(19) United States
(12) Patent Application Publication
(10) Pub. No.: US 2007/0008686 A1
(43) Pub. Date: Jan. 11, 2007

(54) DISPLAY APPARATUS

(76) Inventor: Se-ki JANG, Suwon-si (KR)

Correspondence Address: STANZIONE & KIM, LLP, 919 18TH STREET, N.W., SUITE 440, WASHINGTON, DC, 20006, US

(21) Appl. No.: 11/427,950

(22) Filed: Jun. 30, 2006

(30) Foreign Application Priority Data
Jul. 11, 2005 (KR) 2005-62110

(51) Int. Cl. G06F 1/16; A47G 29/00; F16M 11/00

(52) U.S. Cl. 361/681; 248/917; 248/371; 248/122.1

(57) ABSTRACT

A display apparatus includes a base, a display disposed at an upper side of the base, a stand provided between the base and the display, and a pivot supporter provided between the display and the stand to support a pivoting operation between an upright position in which the stand extends to a lower side of the display and a packing position in which the stand is pivoted from the upright position to a rear side of the display. Accordingly, the display apparatus has a reduced packing size, is convenient to use, and has a simple structure.

### CROSS-REFERENCE TO RELATED APPLICATIONS

This application claims the benefit of priority under 35 U.S.C. §119 from Korean Patent Application No. 2005-62110, filed with the Korean Intellectual Property Office on Jul. 11, 2005, the disclosure of which is incorporated herein by reference in its entirety.

### BACKGROUND OF THE INVENTION

1. Field of the Invention

The present general inventive concept relates to a display apparatus, and more particularly, to a display apparatus with an improved coupling structure including a display and a stand.

2. Description of the Related Art

Generally, a display apparatus commonly refers to a TV, a monitor for a computer and the like, and functions to form an image using a CRT (Cathode Ray Tube), an LCD (Liquid Crystal Display), a PDP (Plasma Display Panel), etc. Recently, a thin display panel using the LCD or the PDP, which can form a relatively large screen in comparison with its thickness, has been widely used in the display apparatus.

This display apparatus includes a display having the thin display panel for forming an image, a base for supporting the display, and a stand provided between the display and the base.

A thin display apparatus having a conventional stand is disclosed in Korean Laid-open No. 10-2003-0015642. The conventional stand for a monitor includes a bracket disposed at a rear surface of the monitor and a stand coupled to the bracket to support the monitor. The stand is removably fixed to the monitor by a screw so as to be separated from the monitor, thereby reducing a packing size when packing the monitor.

In the display apparatus, since the conventional stand is detachably fixed to the monitor, it is possible to reduce the packing size. However, there is an inconvenience in using the display apparatus in that a user is required to assemble the display apparatus and to couple the stand to the monitor using the screws and other fasteners and installation pieces.

### SUMMARY OF THE INVENTION

Accordingly, the present general inventive concept provides a display apparatus which has a reduced packing size, is convenient to use, and has a simple structure.

Additional aspects of the present general inventive concept will be set forth in part in the description which follows and, in part, will be obvious from the description, or may be learned by practice of the general inventive concept.

The foregoing and/or other aspects of the present general inventive concept can be achieved by providing a display apparatus comprising a base, a display disposed at an upper side of the base, a stand provided between the base and the display, and a pivot supporter provided between the display and the stand to support a pivoting operation between an upright position in which the stand extends to a lower side of the display and a packing position in which the stand is pivoted from the upright position to a rear side of the display.

The pivot supporter may comprise a display bracket disposed on the rear side of the display, a stand bracket disposed on an upper side of the stand to correspond to the display bracket, and a pivot shaft coupled to the display bracket and the stand bracket to rotatably support the stand bracket with respect to the display bracket.

The pivot shaft may be coupled to the display bracket and the stand bracket and is positioned away from a center portion of the display bracket and the stand bracket.

The pivot shaft may be coupled to a center portion of the display bracket and the stand bracket.

The pivot supporter may further comprise a stopper provided at one of the display bracket and the stand bracket to restrict the pivoting operation of the stand in the upright position.

The stopper may be movably accommodated in the display bracket to protrude from the display bracket toward the stand bracket, and the pivot supporter may further comprise an elastic member to bias the stopper to project from the display bracket toward the stand bracket.

The display apparatus may further comprise at least one hook formed at one of the base and the stand, and at least one coupler formed at the other one of the base and the stand to be coupleable with and releasable from the at least one hook.

The display apparatus may further comprise a stand accommodating portion recessed in a surface of the base to receive a lower side of the stand, wherein the at least one hook is provided at the stand and the at least one coupler is provided at the stand accommodating portion.

It is to be understood that both the foregoing is a general description, and the following detailed description is exemplary and explanatory and is intended to provide further explanation of the general inventive concept, as claimed below.

The foregoing and/or other aspects of the present general inventive concept can also be achieved by providing a display apparatus comprising a display, a stand to support the display when in an upright position, and a pivot supporter to fixedly connect a first end of the stand to the display and to allow the stand to rotate about the first end with respect to the display to and from the upright position.

The foregoing and/or other aspects of the present general inventive concept can also be achieved by providing a display supporting apparatus comprising a stand to be connected to a display, a base detachably connected to the stand, and a pivot supporter rotatably supporting the stand with respect to the display between a first position and a second position. The pivot supporter is disposed between the stand and the display.

The foregoing and/or other aspects of the present general inventive concept can also be achieved by providing a display apparatus, comprising a display, a stand connected to a rear side of the display, a pivot supporter to rotatably support the stand with respect to the display between a first position and a second position, and a removable stopper to automatically latch the stand in the first position when the stand is rotated from the second position.

### BRIEF DESCRIPTION OF THE DRAWINGS

These and/or other aspects of the prevent general inventive concept will become apparent and more readily appreciated from the following description of the embodiments, taken in conjunction with the accompany drawings of which:

FIG. 1 is a rear perspective view illustrating a display apparatus according to an embodiment of the present general inventive concept;

FIGS. 2 and 3 are exploded perspective views illustrating a stand and a base of the display apparatus of FIG. 1;

FIG. 4 is an operational view illustrating the stand of the display apparatus of FIG. 1;

FIG. 5 is a rear perspective view illustrating a display apparatus according to another embodiment of the present general inventive concept;

FIG. 6 is an exploded perspective view illustrating a stand of the display apparatus of FIG. 5; and

FIG. 7 is an operational view illustrating the stand of the display apparatus of FIG. 5.

### DETAILED DESCRIPTION OF THE EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

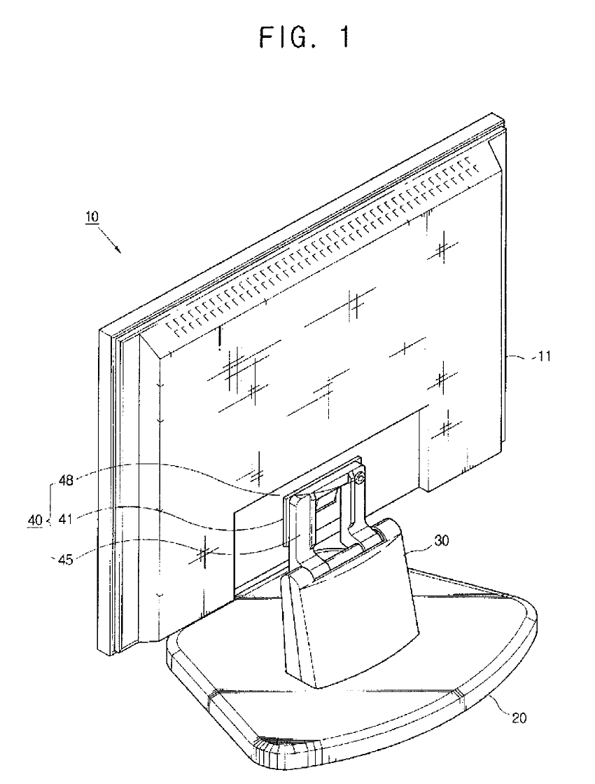

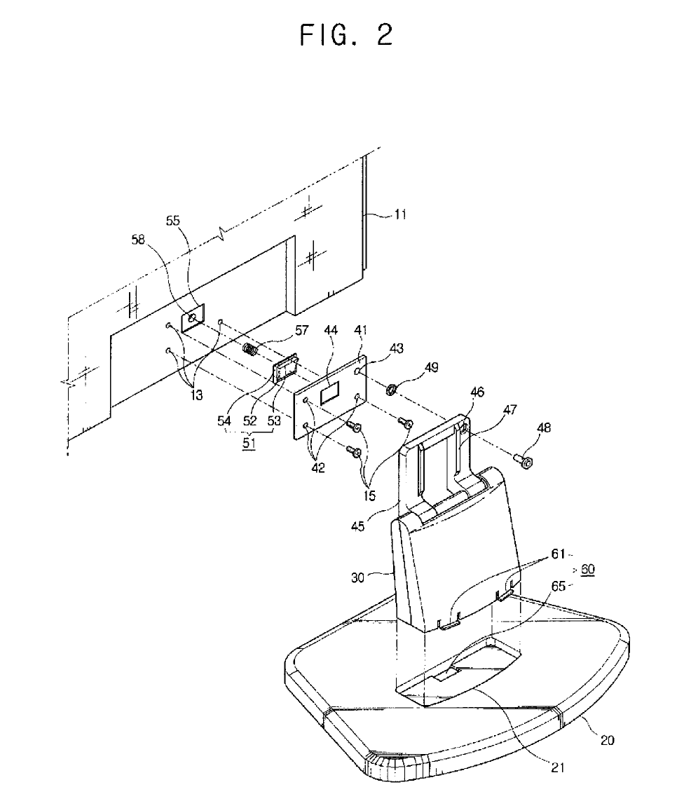

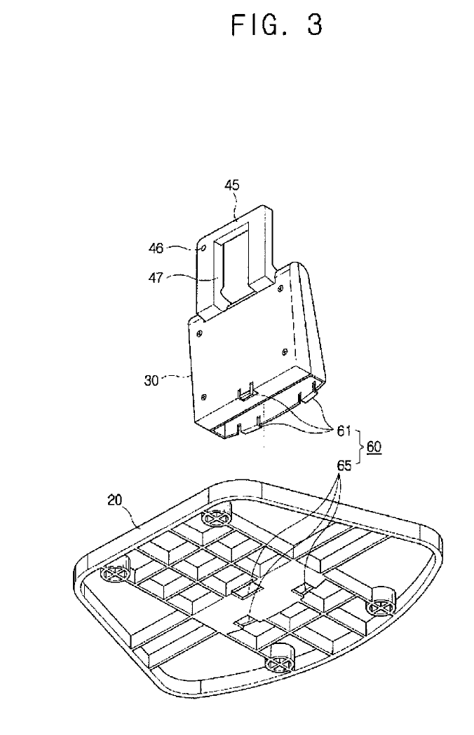

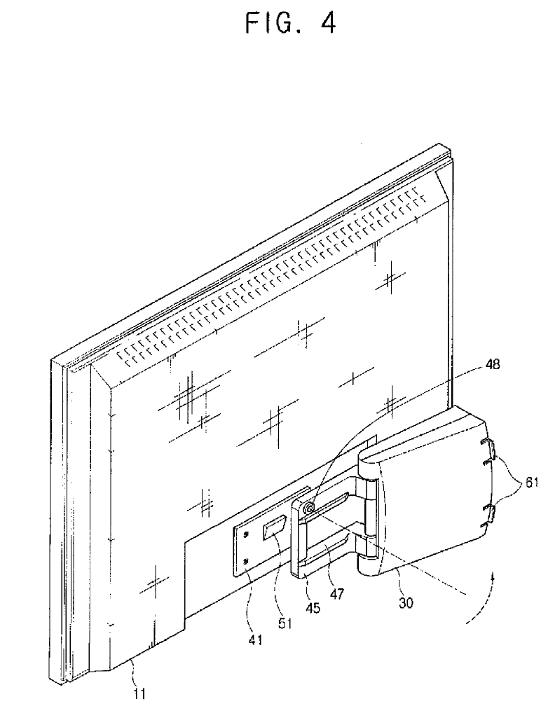

FIG. 1 is a rear perspective view illustrating a display apparatus according to an embodiment of the present general inventive concept; FIGS. 2 and 3 are exploded perspective views illustrating a stand 30 and a base 20 of the display apparatus of FIG. 1; and FIG. 4 is an operational view illustrating the stand 30 of the display apparatus of FIG. 1. As illustrated in FIGS. 1 to 4, the display apparatus includes the base 20 settled on an installation surface such as a table, a display 10 disposed at an upper side of the base 20, the stand 30 disposed between the base 20 and the display 10, and a pivot supporter 40 disposed between the display 10 and the stand 30 so as to support a pivoting operation (motion) between a using position (i.e., an upright position) where the stand 30 extends to a lower side of the display 10 and a packing position where the stand 30 is pivoted from the upright position to a rear side of the display 10.

The display 10 includes a thin display panel (not shown) such as an LCD panel to form an image, and a casing 11 provided at a rear and front side of the thin display panel so as to protect the rear and the front side of the thin display panel. As illustrated in FIGS. 1 and 2, a display bracket 41 of the pivot supporter 40 (described below) is coupled to the casing 11 provided at the rear side of the display 10.

As illustrated in FIGS. 1 to 3, the base 20 has a plate shape which is capable of being settled on a desired installation surface (e.g., a table, desk, etc). The base 20 is formed with a stand accommodating portion 21 which is recessed to receive a part of a lower side of the stand 30.

The stand accommodating portion 21 is recessed from an upper surface to a lower side of the base 20 so as to receive the lower side of the stand 30. The stand accommodating portion 21 is formed with a coupler 65 of a coupling unit 60 (described below).

The stand 30 is provided between the display 10 and the base 20 to support the display 10. An upper portion of the stand 30 is coupled to the display 10, and a lower portion thereof is detachably coupled to the base 20. A stand bracket 45 of the pivot supporter 40 (described below) is provided at the upper portion of the stand 30. The lower portion of the stand 30 is coupled to the base 20 by the coupling unit 60. The lower portion of the stand 30 is accommodated in the stand accommodating portion 21 of the base 20. The stand 30 is coupled to the display 10 by the pivot supporter 40 so as to be movable between the using position exposed to the lower side of the display 10 (in which the stand 30 extends to the lower side of the display 10) so as to support the display 10 against the stand 30 and the packing position (see FIG. 4) in which the stand 30 is pivoted from the using position to a rear side of the display 10 to reduce the packing size by separating the base 20 from the stand 30. Thus, the pivot supporter 40 enables the stand 30 to be removed from the base 20 and pivoted behind the display 10 around a rotational axis that is perpendicular to the display 10 such that the packing size can be reduced without disassembling the display 10 and the stand 30.

The coupling unit 60 includes a hook 61 formed at one of the base 20 and the stand 30, and a coupler 65 formed at the other of the base 20 and the stand 30 so as to be coupled with or released from the hook 61.

For example, as illustrated in FIGS. 2 and 3, the hook 61 may be formed at the lower portion of the stand 30. The hook 61 may include a plurality of hooks 61 so as to maintain a strong coupling force between the stand 30 and the base 20. Any number of hooks 61 can be provided.

As illustrated in FIGS. 2 and 3, the coupler 65 may be formed in the stand accommodating portion 21 of the base 20 so as to be engaged by the hook 61. The coupler 65 may include a plurality of couplers 65 formed in the stand accommodating portion 21 so as to be engaged by each of the hooks 61.

Therefore, a user can insert the lower portion of the stand 30 into the stand accommodating portion 21 of the base 20, and at the same time, couple the plurality of hooks 61 formed at the stand 30 to the couplers 65 formed in the stand accommodating portion 21. Then, after releasing the hooks 61 coupled with the couplers 65 on a lower side of the base 20, the user can separate the stand 30 from the stand accommodating portion 21.

The pivot supporter 40 includes the display bracket 41 provided at the rear side of the display 10, the stand bracket 45 provided at the upper side of the stand 30 to correspond to the display bracket 41, and a pivot shaft 48 coupled to the display bracket 41 and the stand bracket 45 so as to rotatably support the stand bracket 45 with respect to the display bracket 41. That is, the stand bracket 45 may be rotated about the rotational axis with respect to the display bracket 41, or vice versa. The rotational axis is defined by the pivot shaft 48. The pivot supporter 40 further includes a stopper 51 provided at one of the display bracket 41 and the stand bracket 45 so as to restrict the pivoting of the stand 30 when in the using position (i.e., the upright position).

The display bracket 41 has a plate shape and couples to the rear side of the display 10. The display bracket 41 includes a plurality of bracket coupling holes 42 provided to be coupled by screws 15 with screwing holes 13 of the casing 11 formed at the rear side of the display 10, and a display through-hole 43 provided to receive the pivot shaft 48. A stopper supporting portion 44 is further provided at the display bracket 41 so as to movably support the stopper 51.

The bracket coupling holes 42 are formed to accommodate a head portion of each screw 15 so that the head portion of each screw 15 is prevented from protruding to an outer side of a surface of the display bracket 41 and thus from being interfered with by the stand bracket 45.

The display through-hole 43 is positioned toward one side of the display bracket 41 away from a center portion of the display bracket 41 so as to accommodate the pivot shaft 48.

The stopper supporting portion 44 is provided at the center portion of the display bracket 41 so as to movably support the stopper 51. The stopper supporting portion 44 is formed at the display bracket 41 so that an inclined portion 52 and a latching jaw 53 of the stopper 51 (described later) can extend through the stopper supporting portion 44 to engage the stand bracket 45.

The stand bracket 45 has a plate shape and is coupled to the upper portion of the stand 30. The stand bracket 45 includes a stand through hole 46 provided to receive the pivot shaft 48. The stand bracket 45 is formed with a stopper coupling portion 47 so as to engage the stopper 51, thereby restricting the pivoting of the stand 30 with respect to the display 10 when the stand 30 is pivoted to the using position. As illustrated in FIGS. 2 and 3, the stopper coupling portion 47 catches the latching jaw 53 of the stopper 51 when the stand 30 is pivoted about the rotational axis defined by the pivot shaft 48 to the using position.

The stand through hole 46 is positioned away from a center portion of the stand bracket 45 toward one side so as to accommodate the pivot shaft 48 and to correspond to the display through hole 43.

The stopper coupling portion 47 is formed at the center portion of the stand bracket 45 to correspond to the stopper supporting portion 44. The stopper coupling portion 47 accommodates the inclined portion 52 and the latching jaw 53 of the stopper 51, and is formed at the stand bracket 45 so as to maintain a latched state with the latching jaw 53.

As illustrated in FIG. 4, the pivot shaft 48 couples to the display through hole 43 and the stand through hole 46 so that the stand 30 can pivot around the rotational axis that extends in a front and rear direction with respect to the display 10. For example, the pivot shaft 48 may have a pipe shape and may be coupled to the display through hole 43 and the stand through hole 46 by a caulking method in which one end of the pivot shaft 48 is inserted into the display through hole 43 and the stand through hole 46, and the other end of the pivot shaft 48 can be bent outward, thereby fixing the pivot shaft 48 in the display and stand through holes 43 and 46. However, the pivot shaft 48 may be fixedly coupled to the display through hole 43 and the stand through hole 46 by various other methods such as screwing, etc. At least one washer 49 may also be provided between the display through hole 43 and the stand through hole 46 such that the pivot shaft 48 can be inserted therethrough.

The stopper 51 may be movably accommodated in the display bracket 41 so as to protrude from the display bracket 41 toward the stand bracket 45. The stopper 51 includes the latching jaw 53 to prevent the stand 30 from being accidentally moved from the using position to the packing position, and thus maintaining the latched state with the stopper coupling portion 47 of the stand bracket 45. The stopper 51 further includes a separation preventing portion 54 which is contactable with an outer side of the stopper supporting portion 44 so as to prevent the stopper 51 from being separated from the display 10 toward the stand 30, and the inclined portion 52 is formed to be inclined from the latching jaw 53 to the other side thereof opposite to the latching jaw 53. An elastic member 57 is also provided to bias the stopper 51 outward from the display 10 to the stopper coupling portion 47 of the stand bracket 45, and thus to project the stopper 51 from the display bracket 41 toward the stand bracket 45. In order to move the stopper 51 from the stopper supporting portion 44 toward the casing 11 and out of the stopper coupling portion 47 of the stand bracket 45, a stopper accommodating portion 55 is formed in the casing 11.

The latching jaw 53 is formed at an upper area of the stopper 51 to maintain the latched state with the upper side of the stopper coupling portion 47. The inclined portion 52 inclines to gradually protrude from the lower side of the stopper 51 to the upper side thereof.

The separation preventing portion 54 extends from both sides of the stopper 51 so as to contact an outer side of the stopper supporting portion 44 on the display bracket 41. Thus, the stopper 51 is prevented from being separated toward a rear side thereof by the separation preventing portion 54. In other words, the separation preventing portion 54 is wider and longer than the stopper supporting portion 44 such that the stopper 51 is prevented from passing therethrough toward the stand bracket 45.

The elastic member 57 is provided between the casing 11 and the stopper 51 so as to bias the stopper 51 backward toward the stand bracket 45 and through the stopper supporting portion 44. The elastic member 57 is accommodated in an elastic member accommodating portion 58 formed on the casing 11. In the present embodiment, a coil spring may be used as the elastic member 57, however, it should be understood that other various types of elastic members formed of various materials (e.g., having elasticity like rubber) may also be used as the elastic member 57.

Hereinafter, an operation of the stand 30 in the display apparatus according to an embodiment of the present general inventive concept will be described.

A process of moving the stand 30 from the using position to the packing position will be described. As illustrated in FIG. 1, the base 20 coupled to the stand 30 is separated from the stand 30. The user releases the hook 61 from the coupler 65 formed at the lower side of the base 20, and then separates the stand 30 from the stand accommodating portion 21, thereby facilely separating the base 20 from the stand 30.

Then, if the user presses the stopper 51 against the elastic force of the elastic member 57 toward the casing 11, the stopper 51 is moved toward the stopper accommodating portion 55 and out of the stopper coupling portion 47 in the stand bracket 45. Accordingly, the user can pivot the stand 30 around the pivot shaft 48 with respect to the display 10 without resistance from the coupling of the stopper 51 and the stopper coupling portion 47.

As illustrated in FIG. 4, since the stand 30 hardly extends passed a lateral side of the display 10 when the stand 30 is pivoted toward the rear side of the display 10 to the packing position, it is possible to reduce the packing size thereof.

A process of moving the stand 30 from the packing position to the using position will be described. The user pivots the stand 30 from the packing position to the using position. Then, one side of the stand bracket 45 presses the stopper 51 while overcoming the elastic force of the elastic member 57, and moves along the inclined portion 52 of the stopper 51. As the one side of the stand bracket 45 presses the stopper 51 during the pivoting movement, the stopper 51 is moved toward the casing 11 and is accommodated in the stopper accommodating portion 55. Once the one side of the stand bracket 45 passes over the inclined portion 52 and arrives at the using position, the latching jaw 53 and the inclined portion 52 are forced to the stopper coupling portion 47 by the elastic force of the elastic member 57. At this time, the latching jaw 53 of the stopper 51 is latched on the upper side of the stopper coupling portion 47 so as to restrict the pivoting of the stand 30 in the using position (i.e., the upright position). The user inserts the lower portion of the stand 30 into the stand accommodating portion 21 of the base 20, engaging the plurality of hooks 61 formed at the stand 30 with the couplers 65 formed in the stand accommodating portion 21, thereby facilely coupling the base 20 to the stand 30.

Therefore, in the display apparatus according to the present embodiment, the stand 30 can be pivoted from the using position to the packing position without separating the stand 30 from the display 10, thereby reducing the packing size. Further, the stand 30 and the base 20 can be facilely coupled and separated from each other.

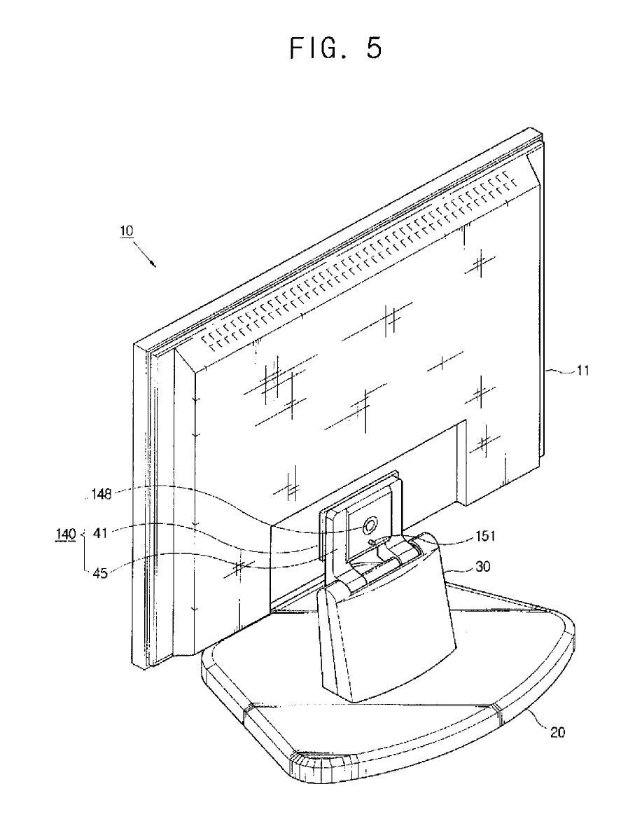

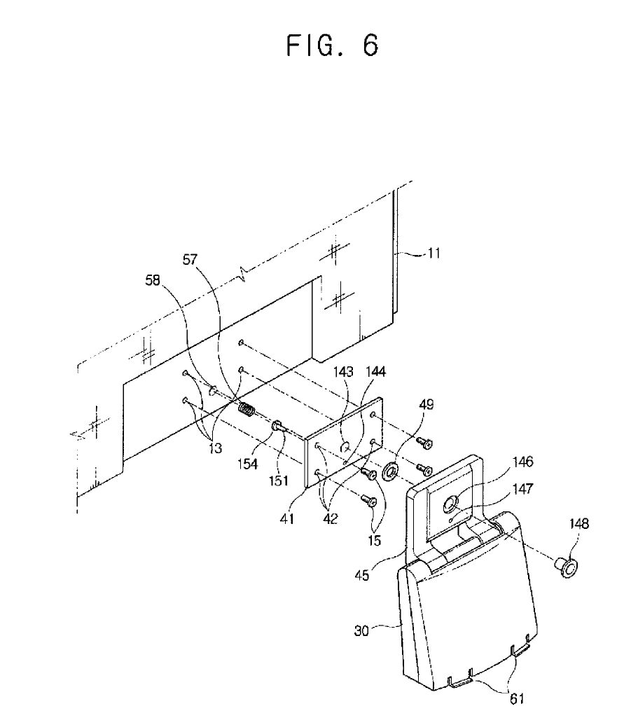

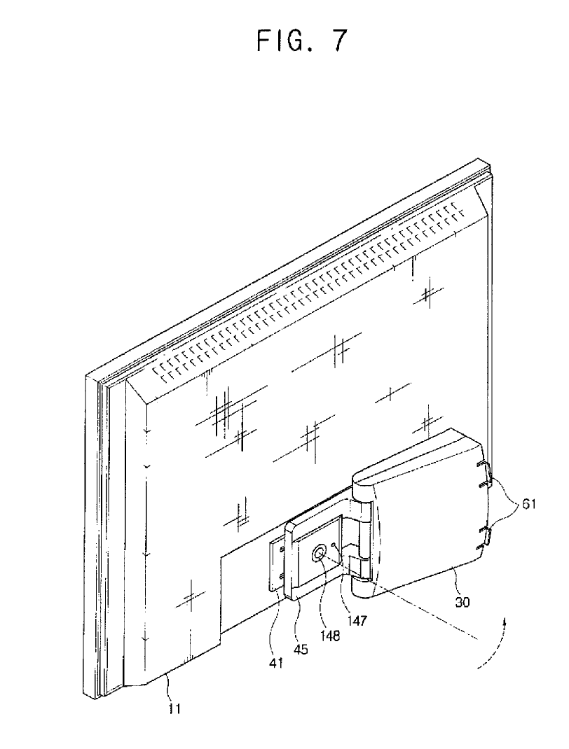

FIG. 5 is a rear perspective view illustrating a display apparatus according to another embodiment of the present general inventive concept, FIG. 6 is an exploded perspective view illustrating a stand 30 of the display apparatus of FIG. 5, and FIG. 7 is an operational view illustrating the stand 30 of the display apparatus of FIG. 5. Some of the components of the display apparatus of the present embodiment are the same as the components of the previous embodiment(s). Accordingly, a description of these components will not be provided below. As illustrated in FIGS. 5 to 7, the display apparatus has a pivot shaft 148 of a pivot supporter 140, which is disposed at a different position from the pivot shaft 48 and the pivot supporter 40 of the previous embodiment(s).

The pivot shaft 148 is inserted into a center portion of the display bracket 41 and the stand bracket 45. That is, a display through hole 143 in which the pivot shaft 148 is inserted is formed at the center portion of the display bracket 41, and a stand through hole 146 in which the pivot shaft 148 is inserted is also formed at the center portion of the stand bracket 45.

Since a method of inserting the pivot shaft 148 into the display through hole 143 and the stand through hole 146 may be the same as described above with reference to the previous embodiment(s), a description thereof will not be provided below. A washer 49 may also be provided between the display through hole 143 and the stand through hole 146.

A stopper 151 is supported in a stopper supporting portion 144 formed at a lower side of the display through hole 143 on the display bracket 41, and is elastically biased toward the stand bracket 45 by an elastic member 57 accommodated in an elastic member accommodating portion 58 of a casing 11. A separation preventing portion 154 is formed at a side of the stopper 151 and around a periphery thereof so as to prevent the stopper 151 from being separated from the stopper supporting portion 144.

A stopper coupling portion 147 is formed at the stand bracket 45 so as to receive the stopper 151 when in the using position such that the stopper 151 extends therethrough.

As described above, the user presses the stopper 151 coupled to the stopper coupling portion 147 toward the casing 11 so that the stopper 151 is separated from the stopper coupling portion 147, and then pivots the stand 30 about the pivot shaft 148 so that the stand 30 can be moved to and from the packing position. When pivoting the stand 30 from the packing position to the using position, as illustrated in FIG. 7, since the stopper 151 is pressed by the stand bracket 45 during the pivoting movement, the user can simply pivot the stand 30 from the packing position to the using position. Once the stand 30 arrives at the using position, the stopper 151 is pushed through the stopper coupling portion 147 by the elastic force of the elastic member 57 so as to restrict the pivoting of the stand 30.

Accordingly, in the display apparatus according to the present embodiment, the stand 30 can be pivoted from the using position to the packing position without separating the stand 30 from the display 10, thereby reducing the packing size. Further, the stand 30 and the base 20 can be facilely coupled and separated from each other.

As described above, the various embodiments of the present general inventive concept provide a display apparatus which has a pivotable stand so as to reduce a packing size. Further, the various embodiments of the present general inventive concept provide a display apparatus which can facilely couple and separate the stand and the base from each other.

Although a few embodiments of the present general inventive concept general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A display apparatus, comprising:
a base;
a display disposed at an upper side of the base;
a stand provided between the base and the display; and
a pivot supporter provided between the display and the stand to support a pivoting operation between an upright position in which the stand extends to a lower side of the display and a packing position in which the stand is pivoted from the upright position to a rear side of the display.

2. The display apparatus according to claim 1, wherein the pivot supporter comprises:
a display bracket disposed on the rear side of the display;
a stand bracket disposed on an upper side of the stand to correspond to the display bracket; and
a pivot shaft coupled to the display bracket and the stand bracket to rotatably support the stand bracket with respect to the display bracket.

3. The display apparatus according to claim 2, wherein the pivot shaft is coupled to the display bracket and the stand bracket and is positioned away from a center portion of the display bracket and the stand bracket.

4. The display apparatus according to claim 2, wherein the pivot shaft is coupled to a center portion of the display bracket and the stand bracket.

5. The display apparatus according to claim 4, wherein the pivot supporter further comprises:
a stopper provided at one of the display bracket and the stand bracket to restrict the pivoting operation of the stand at the upright position.

6. The display apparatus according to claim 5, wherein the stopper is movably accommodated in the display bracket to protrude from the display bracket toward the stand bracket, and the pivot supporter further comprises:
an elastic member to bias the stopper to project from the display bracket toward the stand bracket.

7. The display apparatus according to claim 3, wherein the pivot supporter further comprises:
a stopper provided at one of the display bracket and the stand bracket to restrict the pivoting operation of the stand at the upright position.

8. The display apparatus according to claim 7, wherein the stopper is movably accommodated in the display bracket to protrude from the display bracket toward the stand bracket, and the pivot supporter further comprises:
an elastic member to bias the stopper to project from the display bracket toward the stand bracket.

9. The display apparatus according to claim 1, further comprising:
at least one hook formed at one of the base and the stand; and
at least one coupler formed at the other one of the base and the stand to be coupleable with and releasable from the at least one hook.

10. The display apparatus according to claim 9, further comprising:
a stand accommodating portion recessed in a surface of the base to receive a lower side of the stand,
wherein the at least one hook is provided on the stand and the at least one coupler is provided at the stand accommodating portion.

11. A display apparatus comprising:
a display;
a stand to support the display when in an upright position; and
a pivot supporter to fixedly connect a first end of the stand to the display and to allow the stand to rotate about the first end with respect to the display to and from the upright position.

12. The display apparatus according to claim 11, wherein the pivot supporter comprises a stopper to latch the stand in the upright position to provide stability when the stand and the display are set in the upright position.

13. The display apparatus according to claim 11, further comprising:
a base that is removably coupled to a second end of the stand to support the stand and the display on an installation surface.

14. The display apparatus according to claim 11, wherein the stand is rotatable between the upright position in which the stand extends downward at a rear side of the display, and a packing position in which the stand extends laterally at the rear side of the display.

15. The display apparatus according to claim 11, wherein the pivot supporter comprises:
a display bracket fixed to a rear side of the display and having a display through hole;
a stand bracket fixed to the first end of the stand and having a stand through hole; and
a pivot shaft disposed in the display through hole and the stand through hole such that the stand bracket is rotatable with respect to the display bracket.

16. The display apparatus according to claim 15, wherein the pivot supporter further comprises:
a stopper disposed between the display bracket and the stand bracket to latch the stand in the upright position with respect to the display bracket.

17. The display apparatus according to claim 16, wherein the stopper comprises:
a stopper accommodating portion disposed on the rear side of the display;
a stopper supporting portion extending through the display bracket and corresponding to the stopper accommodating portion;
a stopper coupling portion extending through the stand bracket and corresponding to the stopper supporting portion;
a protruding part movably disposed on the stopper accommodating portion to extend toward the stopper supporting portion and the stopper coupling portion; and
an elastic member to bias the protruding part through the stopper supporting portion such that in a first state the protruding part latches with the stopper coupling portion and prevents rotational movement of the stand with respect to the display, and in a second state the protruding part is displaceable toward the stopper supporting portion against the elastic member such that the protruding part is delatched from the stopper supporting portion and the stand is rotatable with respect to the display.

18. The display apparatus according to claim 17, wherein the stopper supporting portion comprises a rectangular opening positioned at a center portion on the display bracket, the stopper coupling portion comprises a rectangular opening positioned at a center portion on the stand bracket, and the protruding part comprises an inclined portion and a latching jaw to latch with the rectangular opening of the stopper coupling portion according to a biasing force exerted by the elastic member.

19. The display apparatus according to claim 17, wherein the stopper supporting portion comprises a circular opening positioned at a lower portion on the display bracket, the stopper coupling portion a circular opening positioned at a lower portion on the stand bracket, and the protruding part comprises a pin-shaped part to latch with the circular opening of the stopper coupling portion.

20. A display supporting apparatus, the apparatus comprising:
a stand to be connected to a display;
a base detachably connected to the stand; and
a pivot supporter rotatably supporting the stand with respect to the display between a first position and a second position,
wherein the pivot supporter is disposed between the stand and the display.

21. The display supporting apparatus according to claim 20, further comprising:
an adjustable stopper to automatically latch the stand in the first position when the stand is rotated from the second position.

22. The display supporting apparatus according to claim 20, wherein the second position is a rear side of the display.
